(19) United States
(12) Patent Application Publication
(10) Pub. No.: US 2025/0341840 A1
(43) Pub. Date: Nov. 6, 2025

(54) LAND HAZARD COMMUNICATION BETWEEN A LANDING SITE AND A PILOTLESS AIRCRAFT

(71) Applicant: Wisk Aero LLC, Mountain View, CA (US)

(72) Inventors: Mark R. Williamson, Seattle, WA (US); Craig Scheffler, Estes Park, CO (US); Melissa James, Sunnyvale, CA (US)

(73) Assignee: Wisk Aero LLC, Mountain View, CA (US)

(21) Appl. No.: 19/197,319

(22) Filed: May 2, 2025

Related U.S. Application Data
(60) Provisional application No. 63/641,865, filed on May 2, 2024.

(51) Int. Cl. G05D 1/654; G05D 109/22; G05D 111/10; G05D 111/30; G06V 20/17; H04L 9/40

(52) U.S. Cl. CPC G05D 1/654; G06V 20/17; H04L 63/068; G05D 2109/23; G05D 2111/10; G05D 2111/30

(57) ABSTRACT

Embodiments provide a method for land hazard communication. The method includes transmitting a first message to a landing site computing system based at least in part on determining that a pilotless aircraft is within a threshold range of a landing site, the first message comprising a first passcode. The method can further include determining whether a second message comprising a second passcode is received from the landing site computing system in response to the first message, the second passcode corresponding to the first passcode. The method can further include determining a subset of maneuvers for landing condition from a set of maneuvers based at least in part on determining whether the second message comprising a second passcode is received from the landing site computing system. The method can further include causing the pilotless aircraft to perform the subset of maneuvers for the landing condition.

### CROSS-REFERENCES TO RELATED APPLICATIONS

This application claims benefit under 35 USC § 119(e) to U.S. Provisional Patent Application No. 63/641,865 filed May 2, 2024, and entitled “LAND HAZARD COMMUNICATION BETWEEN A LANDING SITE AND A PILOTLESS AIRCRAFT,” the disclosure of which is incorporated by reference herein in its entirety for all purposes.

### TECHNICAL FIELD

The embodiments described herein relate generally to an aircraft. In particular, the embodiments provide an aircraft computing system for communicating with a landing site computing system.

### BACKGROUND

Pilotless aircraft need to be able to determine the status of a landing site to avoid any hazards during landing. A pilotless aircraft should be able to determine whether the landing site is clear of any hazards and to take appropriate action based on the landing site status.

### BRIEF SUMMARY

Various embodiments provide an aircraft computing system for communicating landing hazard information for an aircraft. Some embodiments describe techniques for an aircraft computing system to determine that a pilotless aircraft is within a threshold range of a transceiver associated with a landing site. The aircraft computing system can access an aircraft passcode (e.g., a value, an authenticating code, a digital key) based at least in part on determining that the pilotless aircraft is within the threshold range to the landing site. The aircraft computing system can generate a poll message that includes the aircraft passcode. The techniques described herein can include methods, computing systems for performing one or more steps of the methods, and one or more non-transitory, computer-readable storage media storing instructions for performing one or more steps of the methods.

The aircraft computing system can transmit, via a radio link, the poll message to the landing site transceiver based at least in part on determining that the pilotless aircraft is within the threshold range. The aircraft computing system can then wait for a response from the landing site computing system. The response from the landing site computing system to the aircraft computing system can be an echo message that includes the aircraft passcode. The aircraft computing system can then determine whether the aircraft passcode included in the poll message is included in the echo message. If the aircraft computing system receives an echo message with the same aircraft passcode as in the poll message, then the aircraft computing system can control the pilotless aircraft to perform a first set of maneuvers to land at the landing site. If the aircraft computing system does not receive an echo message with the same aircraft passcode as in the poll message, the aircraft computing system can control the aircraft to perform a second set of maneuvers to divert toward a different landing site.

These and other embodiments are described in further detail below.

### BRIEF DESCRIPTION OF THE DRAWINGS

FIG. 1 is an illustration of an example aircraft approaching a landing site, according to one or more embodiments.

FIG. 2 is an illustration of an example hazard, according to one or more embodiments.

FIG. 3 is an illustration of an example communication between a landing site computing system and an aircraft computing system, according to one or more embodiments.

FIG. 4 is an illustration of an example communication between a landing site computing system and an aircraft computing system, according to one or more embodiments.

FIG. 5 is an illustration of an example table for a land hazard communication between a landing site and a pilotless aircraft, according to one or more embodiments.

FIG. 6 is an illustration of an example signaling diagram for land hazard communication, according to one or more embodiments.

FIG. 7 is an illustration of an example signaling diagram for land hazard communication, according to one or more embodiments.

FIG. 8 illustrates an example process for land hazard communication, according to one or more embodiments.

FIG. 9 illustrates an example process for land hazard communication, according to one or more embodiments.

FIG. 10A is an illustration of an exemplary embodiment of the VTOL aircraft with tilting fan assemblies, according to one or more embodiments.

FIG. 10B is an illustration of an exemplary embodiment of the VTOL aircraft with tilting fan assemblies, according to one or more embodiments.

FIG. 11 illustrates a block diagram of an example flight supervision platform for land hazard communication, according to one or more embodiments.

### DETAILED DESCRIPTION

Techniques disclosed herein relate generally to an aircraft computing system that can communicate with a landing site computing system. More specifically, techniques disclosed describe an aircraft computing system that can communicate with a landing site computing system and determine whether to land at the landing site based on the communication with the landing site computing system. Various inventive embodiments are described herein, including methods, processes, systems, devices, and the like.

In order to better appreciate the features and aspects of the aircraft according to the present disclosure, further context for the disclosure is provided in the following section by discussing particular implementations of a vertical take-off and landing (VTOL) aircraft according to embodiments of the present disclosure. These embodiments are for example only, and other configurations can be employed in connection with the aircraft described herein.

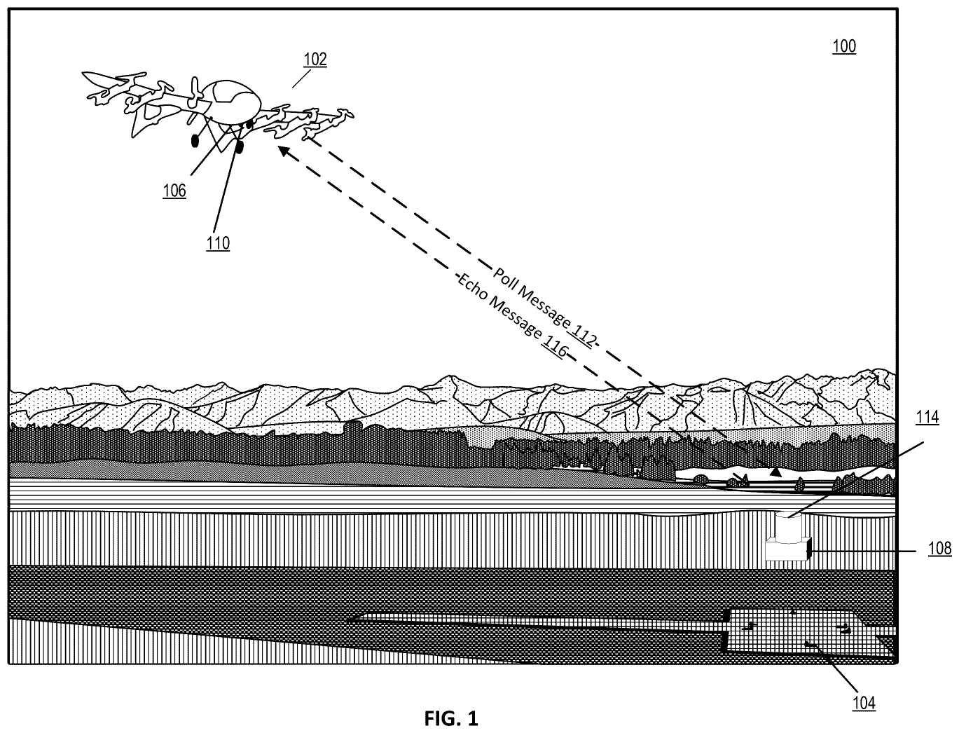

FIG. 1 is an illustration 100 of an example aircraft 102 approaching a landing site, according to one or more embodiments. According to various embodiments, the aircraft 102 (e.g., a piloted aircraft or a pilotless aircraft) may be an electrically powered aircraft. The aircraft 102 can include various types of aircraft (e.g., a fixed wing aircraft, a VTOL aircraft, rotary-wing aircraft). In some embodiments, the aircraft 102 may be configured to carry one or more passengers and/or cargo, and may be controlled automatically and/or remotely (e.g., may not require an on-board pilot to operate the aircraft, and may be controlled based on a control signal or instruction received from a remote entity). The aircraft 102 can include a fuselage, which may include a cabin section for carrying passengers and/or cargo. For example, the cabin section may be provided toward a nose of the aircraft 102. The aircraft 102 may also include a horizontal stabilizer (e.g., a tailplane) coupled to a rear end of the fuselage. The tailplane may be in any suitable shape or form. For example, the tailplane may be V-shaped (e.g., V-tail). A pair of wings are coupled to opposite sides of the fuselage. In some embodiments, the pair of wings may be coupled to the fuselage in a high-wing configuration. That is, the pair of wings may be mounted on an upper portion of the fuselage. A plurality of fan assemblies (e.g., lift fan assemblies and/or tilting fan assemblies) may be coupled to the pair of wings. For example, the aircraft 102 may include a total of twelve fan assemblies (e.g., fans, rotors, propellers) divided equally between the wings. In some embodiments, the fan assemblies may be coupled directly to the wings. In other embodiments, the fan assemblies may be mounted on support structures, such as booms that may be coupled to an underside of the wings.

The aircraft 102 can include an aircraft computing system 106 (e.g., the flight control system) that may be configured to control various aspects of the aircraft, including the aircraft's landing process. The landing process can include a set of maneuvers that include various stages, such as an approach, a flare, a touchdown, and a rollout. An approach stage can include the aircraft 102 descending toward the landing site 104 (e.g., heliport, vertiport, runway). For the approach stage, the aircraft computing system 106 can cause the aircraft 102 to follow a particular path to descend toward the landing site 104. For example, the approach can include the computing system causing the aircraft 102 to be aligned with the landing site 104 and adjusting a speed of the aircraft 102. An aircraft 102, such as a VTOL-type aircraft, can include a transition stage, in which the aircraft computing system 106 causes the shift from a vertical flight mode to a horizontal flight mode. The flare stage can include the computing system to reduce the rate of descent for the aircraft 102 before making contact with the landing site 104. An aircraft 102, such as a VTOL-type aircraft, can also hover, in which the aircraft 102 can hover over the landing site 104 prior to gently descending to make contact (e.g., touchdown stage) with the landing site 104. The landing process can also include a rollout stage, in which the computing system causes the aircraft 102 (e.g., fixed wing aircraft) to decelerate after touching down on the landing site 104.

In order for the aircraft computing system 106 to determine the correct control instructions to transmit to various systems on the aircraft 102, the computing system may communicate with a landing site computing system 108 and determine the status of the landing site 104. For example, after aligning with the landing site 104, but before a final descent toward the landing site 104, the aircraft computing system 106 may need to know whether there are any hazards. A hazard can include an object (e.g., vehicle, person, or animal on or near the landing site 104) that can disrupt the landing process for the aircraft 102. A hazard can also include damage, state, or disruption to the landing site 104 or landing site computing system 108 (e.g., landing site computing system not functioning properly, software update, or other state that can disrupt the landing) that can disrupt a landing process. A hazard can also include various environmental conditions or potential environmental conditions (strong winds, earthquake, or flood) that can disrupt the landing process. In a piloted aircraft, the pilot may be available to visually inspect the landing site 104, such that the pilot can cause the aircraft to ascend or maintain a hovering position in the event of a hazard. In a pilotless scenario, the computing system of the aircraft 102 needs to communicate with the landing site 104 to be apprised of the status of the landing site 104. If the landing site 104 is clear of hazards, the aircraft computing system 106 can cause the aircraft 102 to perform a flight maneuver, such as begin and complete its final descent and touchdown at the landing site 104. If, however, there is a hazard at the landing site 104, the aircraft computing system 106 can cause the aircraft 102 to perform another maneuver, such as maintaining a hovering position or flying to an alternate landing site. Furthermore, the communication protocol between the aircraft computing system 106 and the landing site computing system 108 can address four scenarios: (1) the landing site 104 is clear and the landing site computing system 108 is functional, (2) the landing site 104 is clear and the landing site computing system 108 is not functional, (3) the landing site 104 includes a hazard and the landing site computing system 108 is functional, and (4) the landing site 104 includes a hazard and the landing site computing system 108 is not functional.

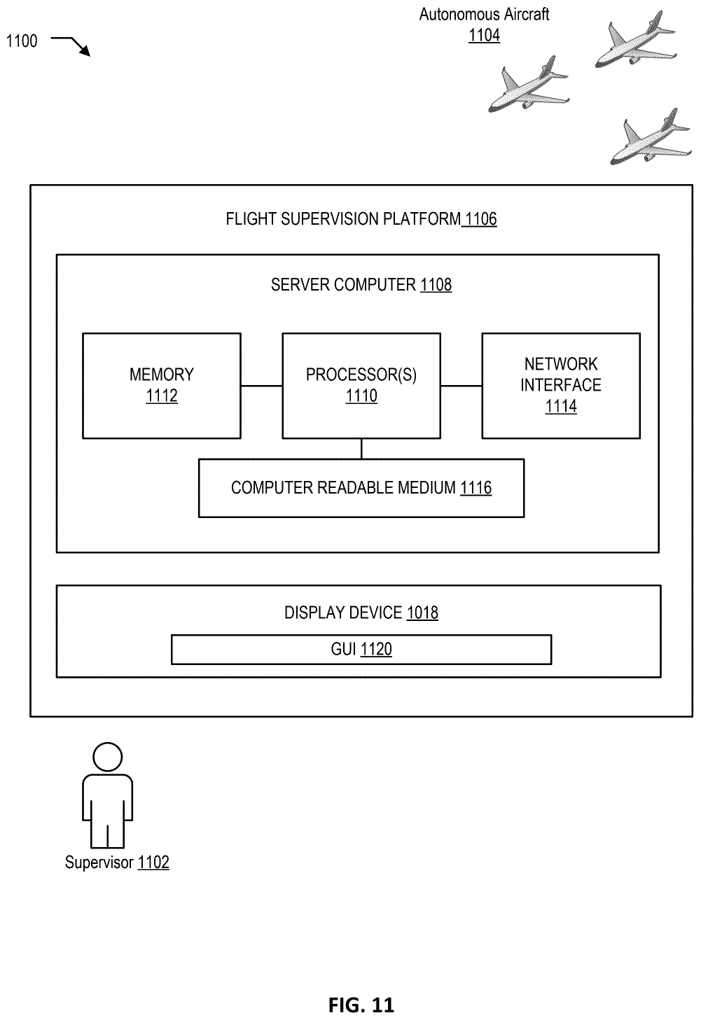

Embodiments herein address the above referenced issues by providing techniques for an aircraft computing system 106 to determine the status of the landing site 104. As an example, either prior to take-off or after take-off, the aircraft 102 can be assigned a landing site 104 (e.g., a final approach take-off area (FATO)) to land during a bounded time frame. The landing site information can be provided to the aircraft computing system 106 by a flight supervision platform as described in FIG. 11. In some instances, the aircraft 102 can further be assigned an alternate landing site. In these instances, the flight supervision platform can provide landing site information for a primary landing site and the alternate landing site to the aircraft computing system 106. The aircraft computing system 106 can receive the landing site information and use the information to navigate the aircraft 102 toward the landing site 104. In some instances, the landing site computing system 108 can receive landing information indicating the aircraft landing times for the landing site 104. The aircraft computing system 106 can use the landing time information to determine a bounded time frame within which to land at the landing site 104.

As the aircraft approaches the landing site 104, the aircraft computing system 106 can determine a radio parameter, such as that the landing site 104 is within a threshold radio signal range. As the aircraft computing system 106 can use the radio signal range information to determine how close the aircraft 102 is to the landing site 104. The radio signal range can be, for example, a range of a radio signal emitted from a landing site computing system 108. It should be appreciated that the aircraft computing system 106 can use various techniques for determining a position of the aircraft (e.g., inertial reference system (IRS), global positing system (GPS), very high-frequency omni-directional range (VOR), non-directional beacon (NDB)), or other techniques). The aircraft computing system 106 can further use various techniques to determine the position of the landing site 104 and consequently the position of the aircraft 102 in relation to the landing site 104. The aircraft computing system 106 can further determine whether the aircraft 102 is within a threshold range of the landing site 104. The range can be based on various parameters (e.g., a reference radio signal range from a landing site computing system 108, or other parameters). If the aircraft computing system 106 determines that the aircraft 102 is within a threshold range of the landing site 104, the aircraft computing system 106 can be configured to determine the status of the landing site 104. In some instances, the aircraft computing system 106 can be configured to determine the status of the landing site 104 more than once prior to attempting to descend onto the landing site 104. In particular, the aircraft computing system 106 can generate a poll message 112 and transmit the poll message 112 from the aircraft 102 (e.g., from a transceiver 110 on the aircraft 102) to the landing site computing system 108. The poll message 112 can be transmitted via an RF link between the aircraft transceiver 110 and a landing site transceiver 114. The poll message 112 can include a passcode, for example, an aircraft identifier, a landing site identifier, or a unique digital key for message authentication. The poll message 112 can further include other relevant information, such as a current time, and expected landing time. In some instances, the unique digital key is provided to the aircraft computing system 106 by a flight supervision platform. In other instances, the aircraft computing system 106 can include a randomizer that can generate the unique digital key. For example, in response to initializing the generation of the poll message 112, the aircraft computing system 106 can access the randomizer to generate the unique digital key to be included in the poll message.

It should be appreciated that the aircraft computing system 106 and the transceiver 110 can perform multiple functions in addition to generating the poll message 112. For example, the aircraft computing system 106 and the transceiver 110 can be used for digital and voice communications with an air navigation service provider (ANSP). The ANSP can be an entity that manages the aircraft 102 in flight for safe and efficient air travel.

The aircraft computing system 106 can use a direct radio frequency (RF) method to communicate with the landing site computing system 108. The aircraft computing system 106 and the landing site computing system 108 can communicate over the same radio frequency. The direct RF method permits the aircraft computing system 106 and the landing site computing system 108 to communicate over existing aviation radio frequency spectrum. The direct RF method can minimize the “time on air” that may be needed to effectuate communication between the aircraft computing system 106 and the landing site computing system 108.

The landing site computing system 108 can include a repeater (e.g., a store and forward repeater), that includes a receiver, a memory, a controller, a transmitter, and a power supply. The landing site computing system 108 can store the poll message 112 in the memory (e.g., cache). The landing site computing system 108 can process the poll message 112 for validation. For example, the landing site computing system 108 can access aircraft landing information that includes information related to expected landings at the landing site. For example, the aircraft landing information can indicate an expected aircraft to be landing at the landing site 104. The landing site computing system 108 can compare the aircraft identifier and the landing site identifier included in the poll message 112 with an expected aircraft identifier and the landing site identifier of the landing site 104 stored in memory. The landing site computing system 108 can determine whether the aircraft 102 is landing at an expected time. For example, the landing site computing system 108 can compare the expected landing time from the poll message 112 with the current time as determined by the landing site computing system 108. The landing site computing system 108 can determine whether the poll message 112 is current. For example, the landing site computing system 108 can compare the current time from the poll message 112 with the current time as determined by the landing site computing system 108. The landing site computing system 108 can also perform other appropriate checks to validate the poll message 112. It should be appreciated that the landing site computing system 108 may not be able to validate the passcode. However, the landing site computing system 108 may be able to validate the poll message 112 based on the presence of a passcode in the poll message 112. For example, if there is no passcode, the poll message 112 may not be validated.

If the landing site computing system 108 is unable to validate the poll message 112, then the landing site computing system 108 does not respond to the aircraft 102. In this instance, the aircraft computing system 106 can determine that there is a hazard at the landing site 104 and cause the aircraft 102 to take an appropriate action such as performing an appropriate set of maneuvers (e.g., a pilotless aircraft motion, such as diverting to an alternate landing site).

If the landing site computing system 108 is able to validate the poll message 112, then the landing site computing system 108 can check its local memory or an external source (e.g., an external server or other external source) to determine whether it has received hazard information indicating that there is a hazard at the landing site 104. If there is no hazard information stored in memory, the landing site computing system 108 can access the poll message 112 from memory and transmit an echo message 116 back to the aircraft computing system 106. The echo message 116 can include one or more items of duplicate information (e.g., aircraft identifier, unique digital key for message authentication, or other information) from the poll message 112. In some embodiments, the landing site computing system 108 may not introduce any new information into the poll message 112 to form the echo message 116.

The aircraft computing system 106 can receive the echo message 116 from the landing site computing system 108 or in some instances from a relay device in communication with the landing site computing system 108. For example, the relay device can include a transceiver that is configured to relay a poll message 112 from the aircraft computing system 106 to the landing site transceiver 114 for the landing site computing system 108 and relay an echo message 116 from the landing site computing system 108 to the aircraft computing system 106. The aircraft computing system 106 can compare the duplicate information from the echo message 116 with the poll message 112. This can include the information (e.g., does the unique digital key in the echo message 116 match the unique digital key used for the poll message 112). In some instances, the aircraft computing system 106 can also compare the order of the duplicate information (e.g., is the aircraft identifier indicated before the unique digital key) in the echo message 116 to determine whether the order is the same as in the poll message 112. If the echo message 116 has duplicated information from the poll message 112, the aircraft computing system 106 can determine that the landing site 104 has no hazard. Based on determining that the landing site 104 has no hazard, the aircraft computing system 106 can cause the aircraft 102 to perform a pilotless aircraft motion, such as landing at the landing site 104.

If there is hazard information stored in memory, the landing site computing system 108 does not transmit the echo message 116 to the aircraft computing system 106. In this instance, the aircraft computing system 106 can determine that there is a hazard at the landing site 104 and cause the aircraft 102 to take an appropriate action (e.g., a pilotless aircraft motion, such as diverting to an alternate landing site). In some instances, the aircraft computing system 106 can start a timer upon transmitting the poll message 112. The aircraft computing system 106 can wait until expiration of the timer to determine whether an echo message 116 is to be received. If no echo message 116 is received upon expiration of the timer, then the aircraft computing system 106 can determine that no echo message 116 will be received and take an appropriate action (e.g., a pilotless aircraft motion, such as diverting to an alternate landing site).

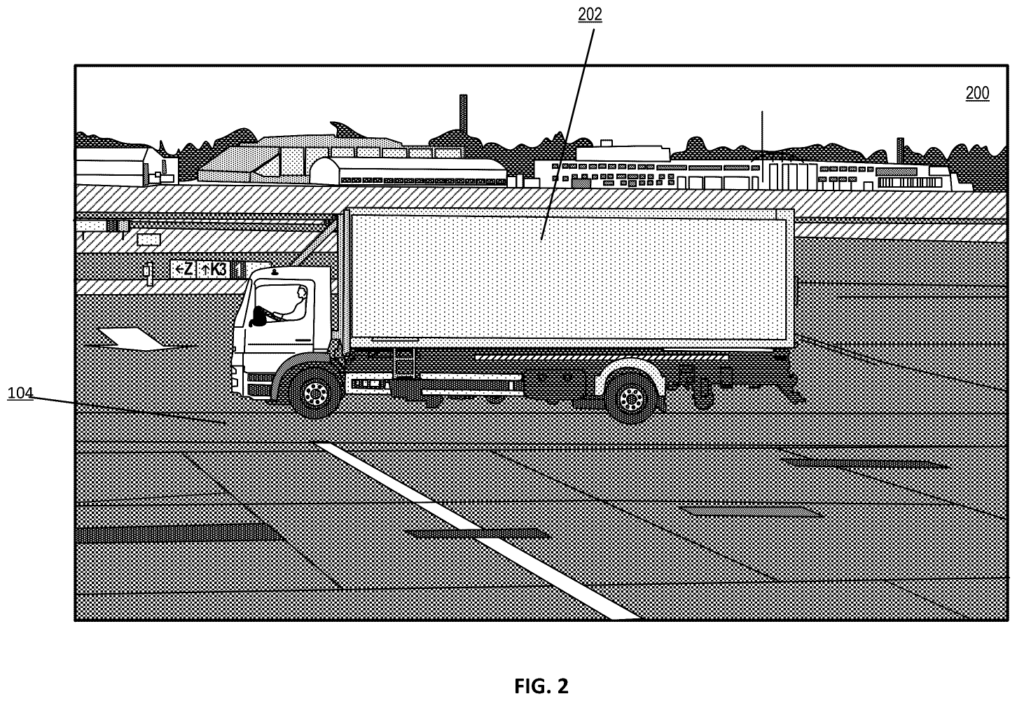

FIG. 2 is an illustration of an example hazard, according to one or more embodiments. As illustrated, a hazard 202 is obstructing the landing site 104. As illustrated, the hazard 202 is a truck that has been driven onto the landing site 104. In other instances, the hazard 202 can be an animal that has run onto the landing site 104, damage to the landing site 104, bad weather conditions, or other hazard. In some instances, the landing site computing system (e.g., landing site computing system 108) can receive hazard information prior to receiving a poll message (e.g., poll message 112) from an aircraft (e.g., aircraft 102) via an aircraft computing system (e.g., aircraft computing system 106) or prior to transmitting an echo message (e.g., echo message 116) to the aircraft. In these instances, the landing site computing system does not transmit an echo message.

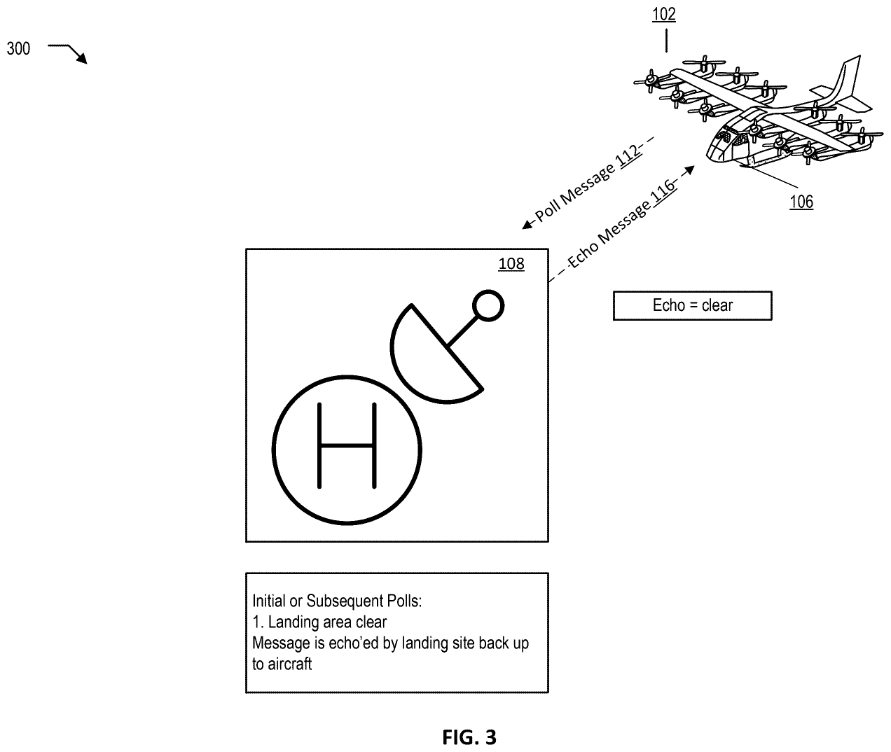

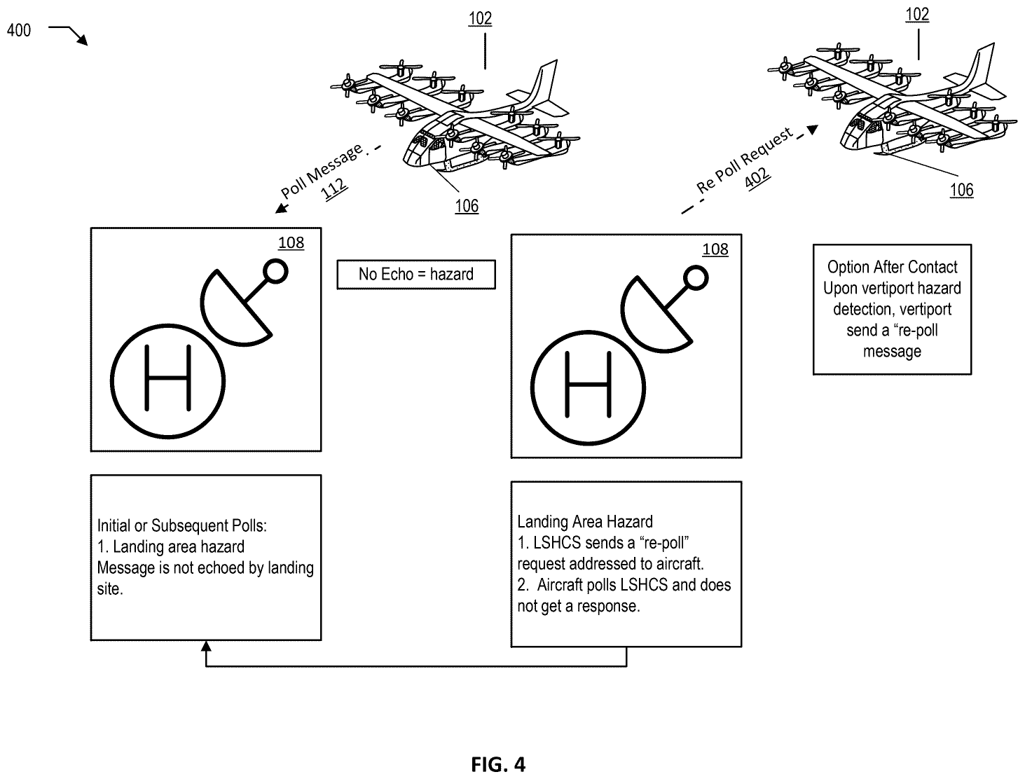

In some instances, the landing site computing system receives hazard information after transmitting an echo message. In some instances, the echo message can be an initial echo message. In other instances, the echo message can be a subsequent echo message. For example, in a situation in which the aircraft transmits multiple poll messages, more than one echo message can be transmitted by the landing site computing system. Therefore, for each poll message that the aircraft transmits, the landing site computing system can respond with an echo message. As an example, if the landing site computing system receives hazard information after transmitting an echo message, it may transmit a request to the aircraft computing system to re-poll the landing site computing system. In response to the request to repoll the landing site computing system, the aircraft computing system can transmit another poll message (e.g., retransmit the poll message 112). In response to the retransmitted poll message, the landing site computing system does not transmit an echo message. The aircraft computing system can determine that there is a hazard at the landing site based on not receiving the echo message. The aircraft computing system can further cause the aircraft to take an appropriate action (e.g., a pilotless aircraft motion, such as diverting to an alternate landing site). This scenario is described with more particularly with respect to FIGS. 3 and 4.

FIGS. 3 and 4 illustrate various scenarios between a landing site computing system and an aircraft computing system. FIG. 3 illustrates communication between and a landing site computing system and an aircraft computing system, according to one or more embodiments. As an aircraft 102 is approaching a landing site (e.g., landing site 104), the aircraft computing system 106 can transmit a poll message 112 to the landing site computing system 108. The landing site computing system 108 can validate the poll message. In the event that the poll message 112 is not validated, the landing site computing system can take no further action. If the poll message 112 is validated, the landing site computing system 108 can access memory to determine whether there is any hazard information. As illustrated, there is no hazard information and therefore, the landing site computing system 108 can transmit an echo message 116 to the aircraft computing system 106. The aircraft computing system 106 can determine whether there is duplicated information from the poll message 112 in the echo message 116 for validation. In the event the echo message 116 is validated, the aircraft computing system can cause the aircraft 102 to land.

FIG. 4 illustrates communication between a landing site computing system and an aircraft computing system, according to one or more embodiments. As an aircraft 102 is approaching a landing site (e.g., landing site 104), the aircraft computing system 106 can transmit a poll message 112 to the landing site computing system 108. The landing site computing system 108 can validate the poll message. In the event that the poll message 112 is not validated, the landing site computing system can take no further action. If the poll message 112 is validated, the landing site computing system 108 can access memory to determine whether there is any hazard information. As illustrated, the landing site computing system 108 can access the memory and initially determine that there is no hazard information and transmit an echo message 116.

After transmitting the echo message 116 and before the aircraft 102 has landed, the landing site computing system 108 can receive hazard information indicating a hazard at the landing site. In response, the landing site computing system 108 can transmit a message (e.g., re-poll request 402) to the aircraft computing system 106 to re-poll the landing site computing system 108. The aircraft computing system 106 can transmit the new polling message to the landing site computing system 108. The landing site computing system 108 can validate the new poll message and access memory for hazard information. If the memory includes hazard information, the landing site computing system 108 does not transmit an echo message (e.g., echo message 116) to the aircraft computing system 106. The aircraft computing system 106 can determine that there is a hazard at the landing site 104 and cause the aircraft 102 to take an appropriate action (e.g., a pilotless aircraft motion, such as diverting to an alternate landing site). If there is no hazard information in memory, the landing site computing system 108 can transmit the echo message 116 to the aircraft computing system 106. The aircraft computing system can cause the aircraft 102 to perform a pilotless aircraft motion, such as landing at the landing site 104.

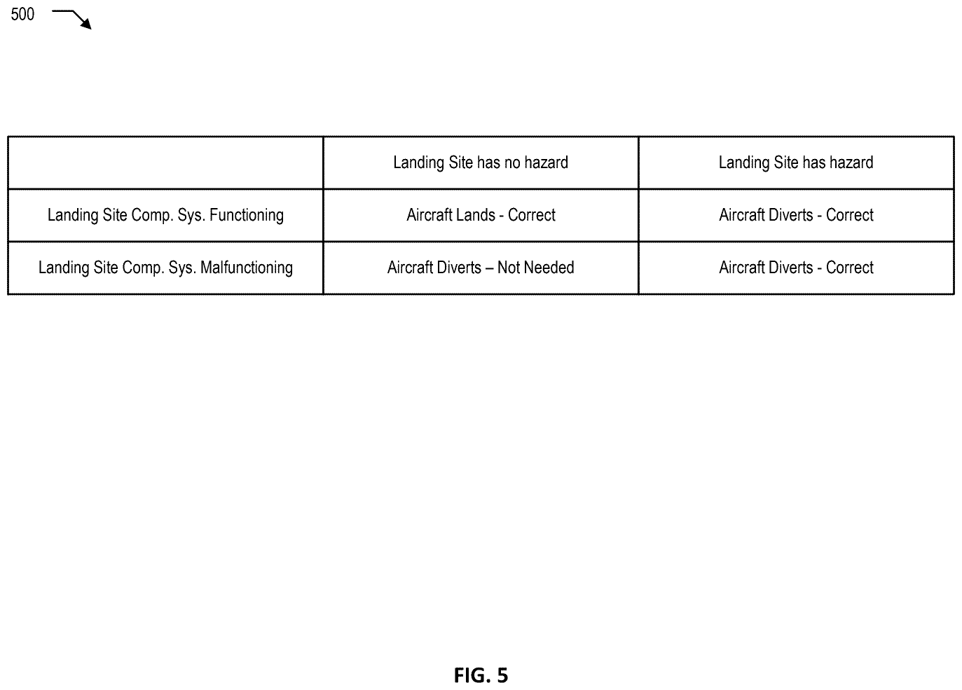

FIG. 5 is an illustration 500 of a table for a land hazard communication between a landing site and a pilotless aircraft, according to one or more embodiments. The land hazard communication can include four possibilities: (1) the landing site computing system is functioning, (2) the landing site computing system is malfunctioning, (3) the landing site has no hazard, and (4) the landing site has a hazard.

In a first scenario, the landing site computing system (e.g., landing site computing system 108) is functioning and there is no hazard at the landing site (e.g., landing site 104). In this scenario, upon receipt of the poll message (e.g., poll message 112), the landing site computing system can transmit an echo message (e.g., echo message 116) to the aircraft computing system and the aircraft can land at the landing site.

In a second scenario, the landing site computing system is malfunctioning and there is no hazard at the landing site. In this scenario, upon receipt of the poll message, the landing site computing system does not transmit an echo message to the aircraft computing system and the aircraft can divert to another landing site.

In a third scenario, the landing site computing system is functioning and there is a hazard at the landing site. In this scenario, upon receipt of the poll message, the landing site computing system does not transmit an echo message to the aircraft computing system and the aircraft can divert to another landing site.

In a fourth scenario, the landing site computing system is malfunctioning and there is a hazard at the landing site. In this scenario, upon receipt of the poll message, the landing site computing system does not transmit an echo message to the aircraft computing system and the aircraft can divert to another landing site.

As illustrated, in each scenario the aircraft can either safely land at a landing site without a hazard, or the aircraft can divert to another landing site.

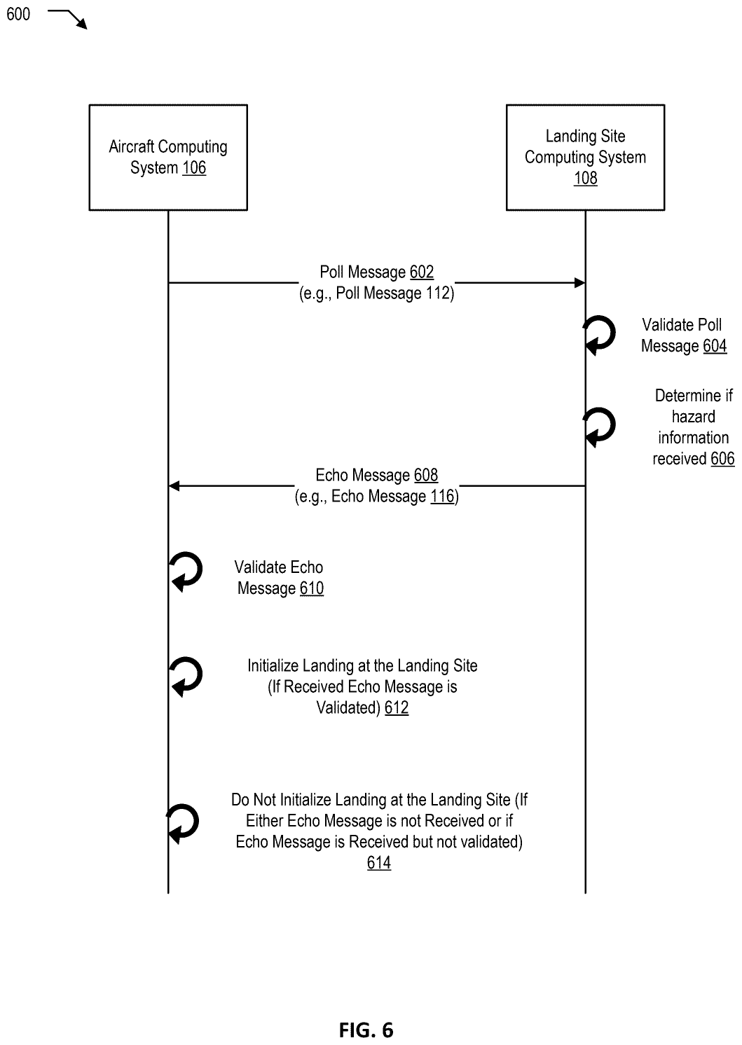

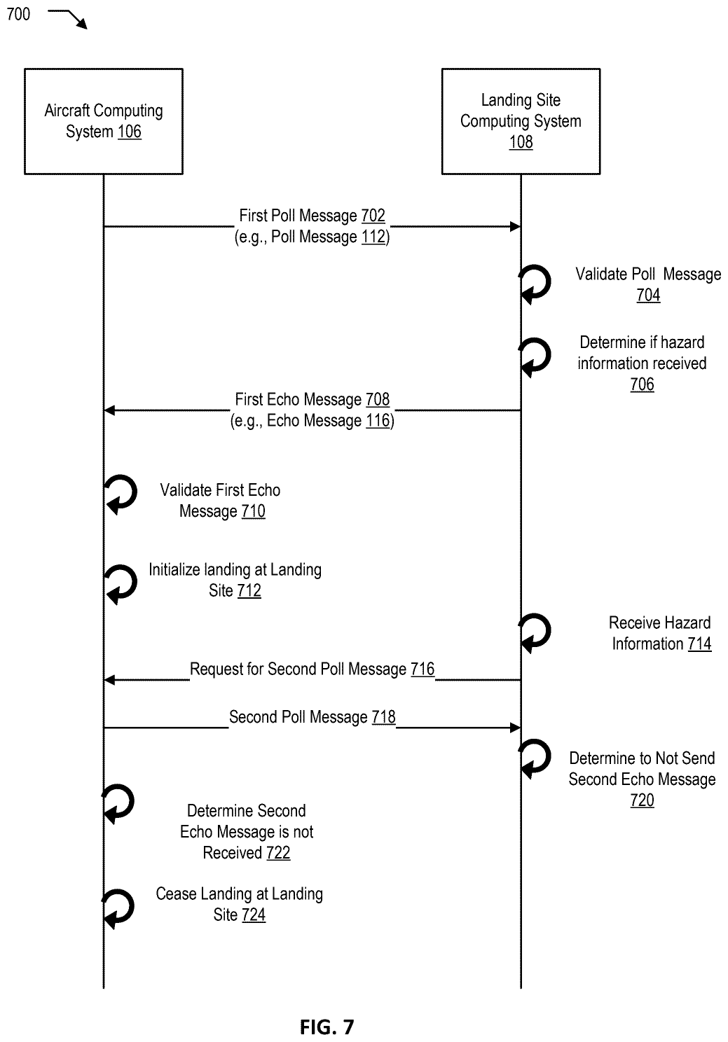

FIGS. 6 and 7 are provided to illustrate signaling between an aircraft computing system 106 and a landing site computing system 108 for land hazard communication.

FIG. 6 is an illustration 600 of an example signaling diagram for land hazard communication, according to one or more embodiments. As illustrated, at 602, an aircraft computing system 106 of an aircraft (e.g., aircraft 102) can transmit a poll message (e.g., poll message 112) to a landing site computing system 108. The poll message can include, for example, an aircraft identifier, a landing site identifier, and a digital key for message authentication. The poll message can further include other relevant information, such as the current time, and expected landing time.

At 604, the landing site computing system 108 can validate the poll message. As described above, the landing site computing system 108 can access aircraft landing information and validate the poll message against this information. If the poll message is not validated, the landing site computing system 108 may take no further action as to the poll message. If the landing site computing system 108 validates the poll message, then it can determine whether any hazard information as to the landing site has been received. The hazard information may be stored in the same location (e.g., server) as the aircraft landing information, or may be stored in another location. In either event, the landing site computing system 108 can access the information to determine whether there is currently a hazard at the landing site. If the landing site computing system determines that there is a hazard, it may take no further action as to the poll message. If the landing site computing system 108 determines that there is no hazard, the landing site computing system 108 can transmit an echo message (e.g., echo message 116) to the aircraft computing system 106 at 608. The echo message can include one or more items of duplicate information (e.g., aircraft identifier, unique digital key for message authentication, or other information) from the poll message.

At 610, the aircraft computing system 106 can validate the echo message. As indicated above, the aircraft computing system 106 can compare one or more items of information from the echo message with information in the poll message to determine if the one or more items of information match.

At 612, if the one or more items of information match, the aircraft computing system 106 can initialize landing and the landing site. The aircraft computing system 106 can further cause the aircraft to perform a first set of maneuvers to land at the landing site.

If, however, the echo message is not received or a received echo message is not validated, the aircraft computing system 106 does not initialize landing at the landing site. For example, the aircraft computing system 106 can start a timer upon transmission of the poll message. If the echo message is not received upon expiration of the timer, the aircraft computing system can determine that the echo message was not received. In these instances, the aircraft computing system can either transmit another poll message or perform a second set of maneuvers divert to an alternate landing site of stay in holding pattern near the landing site.

FIG. 7 is similar to FIG. 6 but describes a scenario in which the landing site computing system receives hazard information after transmitting an echo message. FIG. 7 is an illustration 700 of an example signaling diagram for land hazard communication, according to one or more embodiment. For FIG. 7 steps 702 through 712 are similar to steps 602 through 612 of FIG. 6. At 702, the aircraft computing system 106 can transmit a first poll message to the landing site computing system 108. At 704, the landing site computing system can validate the first poll message. At 706, the landing site computing system can determine whether any hazard information has been received based on validating the first poll message. At 708, the landing site computing system 108 can transmit a first echo message to the aircraft computing system 106 based on determining that there is no hazard information for the landing site. At 712, the aircraft computing system 106 can initialize landing at the landing site. For example, the aircraft computing system 106 can cause the aircraft to perform a first set of maneuvers to land at the landing site.

In some instances, the landing site computing system 108 can receive hazard information after transmitting the echo message. For example, at 714, the landing site computing system 108 can receive information that there is a hazard for the aircraft to land at the landing site. In response, the landing site computing system 108 can transmit a request for a second poll message at 716. At 718, the aircraft computing system 106 can generate the second poll message and transmit it to the landing site computing system 108. The second poll message can be similar to the first poll message, but include updated information, such as an updated passcode. At 720, upon receipt of the second poll message, the landing site computing system 108 can determine not to transmit a second echo message. In some embodiments, the landing site computing system 108 can validate the second poll message before determining not to send the second echo message. At 722, the aircraft computing system 106 can determine that the echo message was not received. In some instances, the aircraft computing system 106 can start a timer upon transmitting the second poll message. The aircraft computing system 106 can wait until expiration of the timer to determine whether a second echo message is to be received. If no second echo message is received upon expiration of the timer, then the aircraft computing system 106 can determine that no echo message will be received. At 724, the aircraft computing system 724 can cease landing at the landing site. For example, the aircraft computing system 106 can cause the aircraft to cease performing a first set of maneuvers for landing at the landing site and cause performance of a second set of maneuvers to either divert the aircraft to an alternate landing site or enter a holding pattern over the landing site.

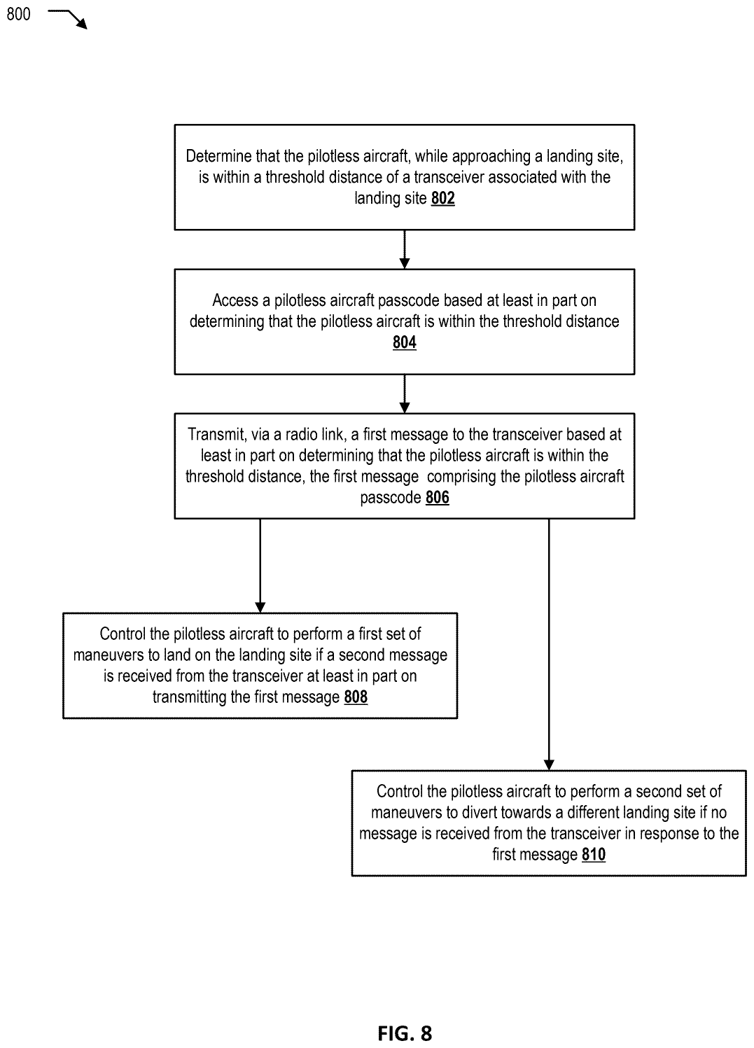

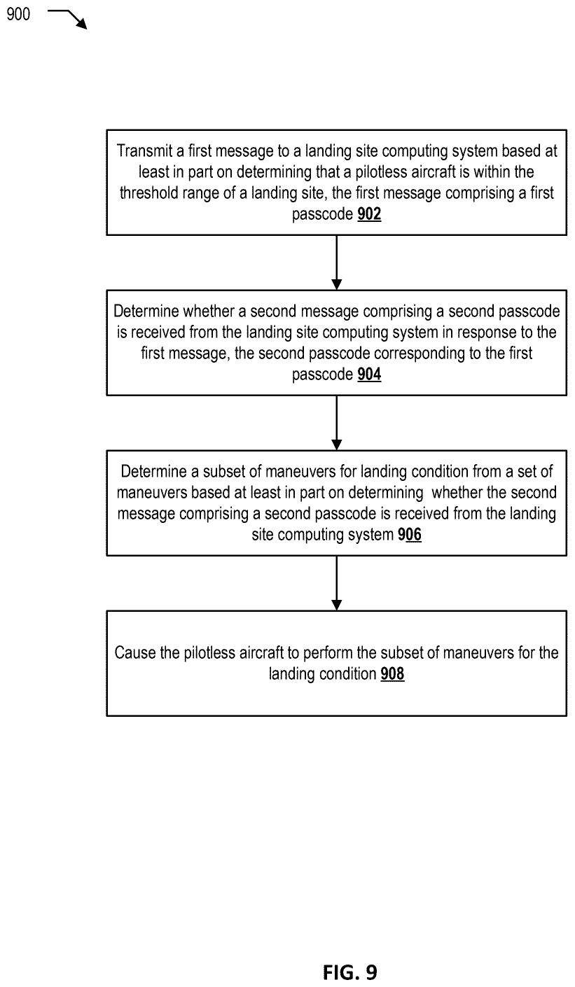

FIGS. 8 and 9 are provided to describe process flows for land hazard communication.

FIG. 8 is an illustration of an example process 800 for land hazard communication, according to one or more embodiments. At 802, the process 800 can include determining that an aircraft (e.g., aircraft 102), while approaching a landing site (e.g., landing site 104), is within a threshold range of a transceiver associated with a landing site. As the aircraft approaches the landing site. The aircraft computing system (e.g., aircraft computing system 106) can determine that the landing site is within a threshold range. The range can be, for example, a range of a radio signal emitted from a landing site computing system (e.g., landing site computing system 108).

At 804, the process 800 can include accessing a pilotless aircraft passcode based at least in part on determining that the pilotless aircraft is within the threshold range. The aircraft computing system can generate a poll message (poll message 112) and transmit the poll message from the aircraft to the landing site computing system. The poll message can be transmitted via an RF link between the aircraft transceiver (e.g., transceiver 110 at the aircraft) and a landing site transceiver. (e.g., landing site transceiver 114). The poll message can include a passcode, for example, an aircraft identifier, a landing site identifier, and a unique digital key for message authentication. The poll message can further include other relevant information, such as a current time, and expected landing time.

At 806, the process 800 can include transmitting, via a radio link, a first message to the transceiver, based at least in part on determining that the pilotless aircraft is within the threshold range, the first message comprising the pilotless aircraft passcode (e.g., aircraft identifier, unique digital key). The aircraft computing system can transmit the poll message to the landing site computing system.

At 808, the process 800 can include controlling the pilotless aircraft to perform a first set of maneuvers to land on the landing site if a second message is received from the transceiver, based at least in part on transmitting the first message. If the landing site computing system determines that there is no hazard at the landing site, then the landing site computing system can transmit an echo message (e.g., echo message 116). In response to receiving the echo message, the aircraft computing system can cause the aircraft to land at the landing site.

The 810, the process 800 can include controlling the pilotless aircraft to perform a second set of maneuvers to divert toward a different landing site if no message is received from the transceiver in response to the first message. If the landing site computing system determines that there is a hazard at the landing site, then the landing site computing system does transmit an echo message. In response to not receiving the echo message, the aircraft computing system can cause the aircraft to divert to another at the landing site. In some instances, the aircraft computing system can receive an incorrect message. For example, the passcode that was included in the poll message may not match the passcode that was included in the echo message.

FIG. 9 is an illustration of an example process 900 for land hazard communication, according to one or more embodiments. At 902, the process can include an aircraft computing system 106 transmitting a first message (e.g., poll message 112) to a landing site computing system 108 based at least in part on determining that a pilotless aircraft (e.g., aircraft 102) is within a threshold range of a landing site 104. The first message can include a first passcode. In some instances, the first passcode is generated while the aircraft is in flight. For example, in some instances the aircraft computing system can use a randomizer to generate the first passcode based at least in part on determining that the pilotless aircraft is within the threshold range of the landing site. The aircraft computing system can further incorporate the first passcode into the first message

In some embodiments, the aircraft computing system 106 can determine a position of the pilotless aircraft as described above. The aircraft computing system can further determine a position of the landing site 104. The aircraft computing system 106 can determine a parameter, where determining that the pilotless aircraft is within the threshold range is based at least in part on the position of the pilotless aircraft, the position of the landing site, and the parameter. The parameter can be a variety of parameters. For example, the parameter can be a radio parameter, such as signal strength. The parameter can also be a time-based parameter. For example, the aircraft computing system 106 can cause a transmit a reference signal toward the landing site and the parameter can be the amount of time before receiving a response signal from the landing site computing system. In another embodiment, the aircraft 102 can be equipped with an image capturing device, such as a camera. The image capturing device can capture an image and the aircraft computing system 106 can utilize a machine learning model that can detect image parameters such as features of objects (e.g., landing site features) from the image. The machine learning model can further be trained to perform distance estimation based on a position of the aircraft 102 at the time the image was captured, the image capturing devices parameters, and the detected features of the objects. It should be appreciated by a person having ordinary skill in the art, that in some embodiments, the herein described poll message and echo message signal techniques can occur without a triggering mechanism such as position determination either based on a radio parameter or an image parameter. For example, the aircraft computing system can transmit the poll message based on various triggers, such as time-based triggering, processing a broadcast message from the landing site computing system to transmit the poll message, configuration to transmit poll message, or other triggering mechanism.

At 904, the process 900 can include the aircraft computing system 106 determining whether a second message (e.g., echo message 116) comprising a second passcode is received from the landing site computing system in response to the first message, the second passcode corresponding to the first passcode. In some embodiments, the second passcode can be identical to the first passcode. In other embodiments, the landing site computing system may perform some mathematical operation on the first passcode. In these embodiments, the aircraft computing system can perform another mathematical operation to determine whether the second passcode corresponds (e.g., is derived from) to the first passcode.

In some embodiments, the aircraft computing system can start a timer based at least in part on transmitting the first message to the landing site computing system 108. The aircraft computing system can further determine an expiration of the timer, wherein determining whether a second message comprising a second passcode is received from the landing site computing system is based at least in part on expiration of the timer.

At 906, the process 900 can include the aircraft computing system 106 determining a subset of maneuvers for landing condition from a set of maneuvers (e.g., a set of maneuvers for landing the aircraft, diverting the aircraft to an alternate landing site, maintaining a holding pattern, or other maneuvers) based at least in part on determining whether the second message comprising a second passcode is received from the landing site computing system.

At 908, the process can include causing the pilotless aircraft to perform the subset of maneuvers for the landing condition.

In some embodiments, the subset of maneuvers is a first subset of maneuvers (e.g., maneuvers for landing at the landing site), wherein the set of maneuvers comprises the first subset of maneuvers and a second subset of maneuvers (e.g., diverting to another landing site or maintaining a holding pattern). In these embodiments, the aircraft computing system can receive a third message (e.g., request for second poll message) requesting the pilotless aircraft to transmit a second poll message. The aircraft computing system 106 can transmit a fourth message comprising a third passcode to the landing site computing system 108 in response to the third message. The aircraft computing system can determine that a fifth message (e.g., second echo message) in response to the fourth message has not been received from the landing site computing system 108. The aircraft computing system can determine to cease performing the first subset of maneuvers based at least in part on determining that the fifth message in response to the fourth message has not been received from the landing site computing system. The aircraft computing system can further determine to perform the second subset of maneuvers based at least in part on determining to cease performing the first subset of maneuvers.

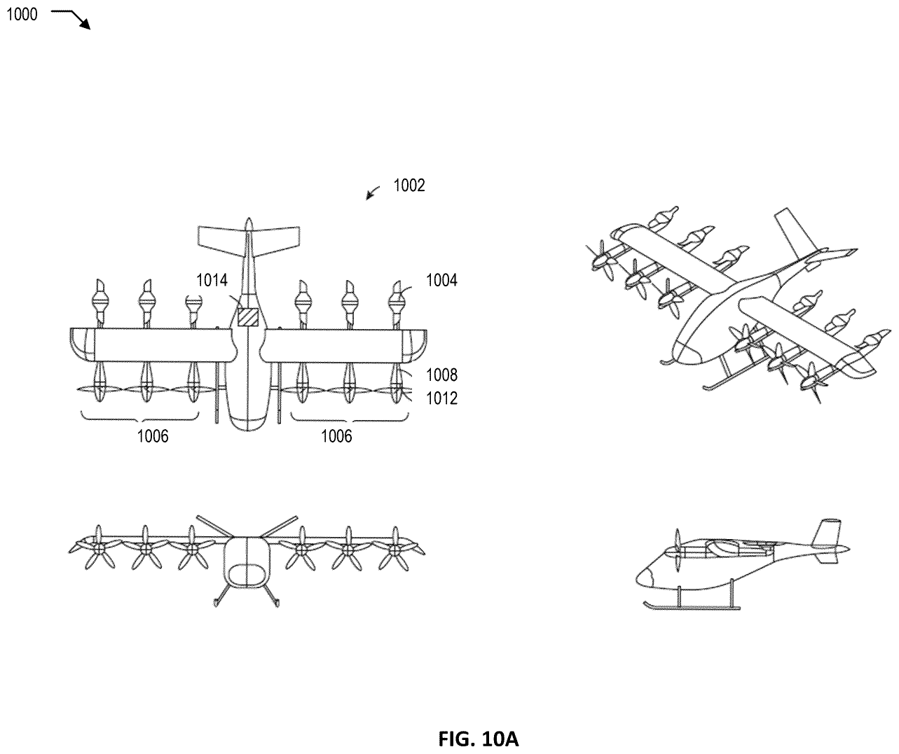

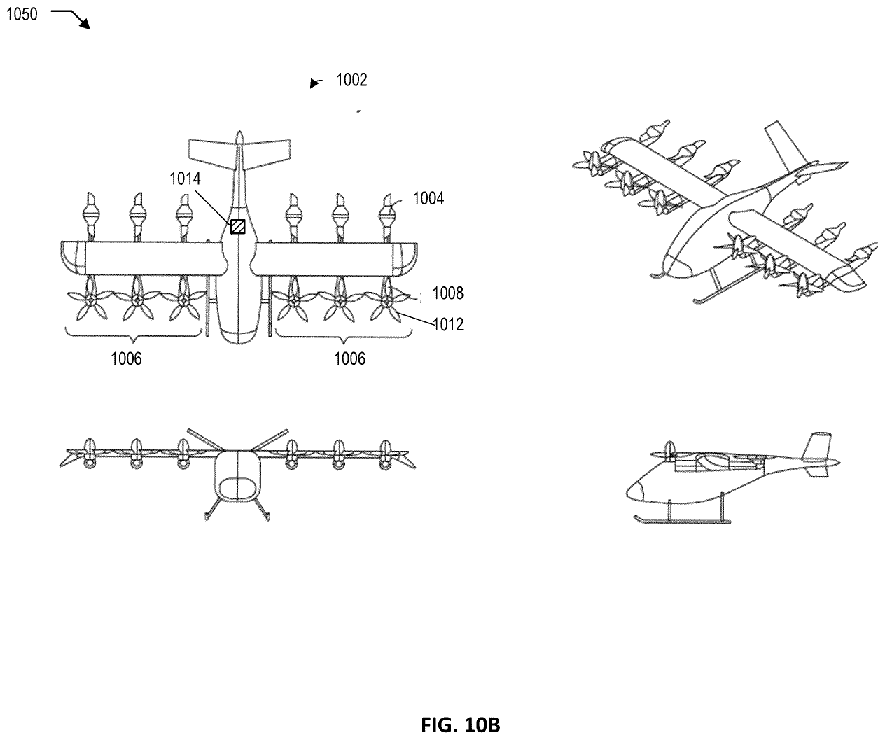

FIGS. 10A and 10B illustrate another exemplary embodiment of the VTOL aircraft with tilting fan assemblies. It should be appreciated that although FIGS. 10A and 10B describe a VTOL aircraft, the embodiments herein can be used for various other types of aircraft (e.g., a fixed wing aircraft, rotary-wing aircraft) FIG. 10A is an illustration 1000 of an exemplary embodiment of the VTOL aircraft with tilting fan assemblies 1004 according to one or more embodiments. FIG. 10B is an illustration 1050 of an exemplary embodiment of the VTOL aircraft with tilting fan assemblies 1004 according to one or more embodiments. In the example embodiment illustrated in FIGS. 10A-10B, a plurality of lift fan assemblies 1004 are provided at a tailing edge of the pair of wings and a plurality of tilting fan assemblies are provided at a leading edge of the pair of wings. The example VTOL aircraft 1002 illustrated in FIGS. 10A-10B includes all front fan assemblies configured as tilting fan assemblies 1006. Thus, in the example VTOL aircraft 1002, all booms 1008 are identical and each includes a tilting fan assembly 1006 on one end and a lift fan assembly 1004 on the opposite end. Since all booms 1008 are identical, the booms 1008 may be interchangeable between the positions on the wings. For example, the first boom closer to the fuselage may be interchangeable with the adjacent second boom (e.g., the middle boom on the wing) or the third boom further away from the fuselage. In some embodiments, each tilting fan assembly 1006 may be coupled to the boom 1008 via an individual tilting mechanism. For example, at least three tilting fan assemblies may be coupled to each of the pair of wings, as shown in FIG. 10A.

FIG. 10A illustrates top, planar, side and front views (clockwise starting from the top left corner) of the VTOL aircraft 1002 with front tilting fan assemblies 1006 with at least one rotor 1012 in the forward flight position. FIG. 10B illustrates top, planar, side and front views (clockwise starting from the top left corner) of the VTOL aircraft 1002 with front tilting fan assemblies 1006 in the vertical lift position (e.g., rotor blade facing upward toward the sky).

The control system 1014 (e.g., aircraft computing system) coupled to the aircraft 1002 may be configured to control the tilting mechanisms 1010 to switch the positioning of the tilting fan assemblies 1006 from the forward flight position (illustrated in FIG. 10A) to the vertical lift position (illustrated in FIG. 10B); as well as from the vertical lift position (illustrated in FIG. 10B) to the forward flight position (illustrated in FIG. 10A). According to various embodiments, the control system 1014 may control the tilting fan assemblies 1006 between the two positions based on sensor data and/or flight data received from the sensors (e.g., sensor measuring air temperature, electric motor temperature, airspeed of the aircraft, etc.), computers, and other input/output devices coupled to the aircraft.

The tilting fan assemblies 1006 may be coupled to the wings via one or more tilting mechanisms, and the tilting fan assemblies 1006 may be controlled individually via the tilting mechanisms 1010. The flight control system 1014 may be configured to control the tilting mechanisms 1010 simultaneously so as to position all tilting fan assemblies 1006 in a same position at the same time. Alternatively, the flight control system may be configured to control the tilting mechanisms 1010 independently from each other. This way, the flight control system may identify one or more tilting fan assemblies 1006 and control the identified tilting fan assemblies 1006 independently from the rest of the tilting fan assemblies. According to various embodiments, the flight control system may use symmetric and/or asymmetric tilting to augment control during hovering and transition (e.g., transition between vertical lift and forward flight). The additional degree of freedom of tilting may augment control during motor out and nominal conditions.

While FIGS. 10A-10B illustrate the tilting fan assemblies 1006 on the front (e.g., leading) edge of the wings and the lift fan assemblies 1004 on the aft (e.g., tailing) edge of the wings, this configuration is for illustrative purposes and should not be construed as limiting. In some embodiments, the lift fan assemblies 1004 may be provided on the leading edge of the wings and the tilting fan assemblies 1004 on the tailing edge of the wings.

Yet in other embodiments, the tilting fan assemblies 1006 and the lift fan assemblies 1004 may be alternated on each one of the front and rear portions of the wings. For example, the leading edge of the first wing may include a first tilting fan assembly 1006, a lift fan assembly 1004 and a second tilting fan assembly 1006. The leading edge of the second wing may include a tilting fan assembly 1006, a lift fan assembly 1004 and another tilting fan assembly 1006. Alternatively, the leading edge of the second wing may include a first lift fan assembly 1004, a tilting fan assembly 1006, and a second lift fan assembly 1004. Similar configurations may be applied to the tailing edge of the first and second wings as well.

In various embodiments, a control system such as the flight control system of the aircraft may be configured to control the actuators (rotors, aerodynamic control surfaces, the tilting fan assemblies, the lift fan assemblies) to cause the aircraft to transition between a vertical lift (e.g., liftoff/hovering/landing) mode and a forward flight mode. For example, the control system may be configured to receive a flight instruction, such as a liftoff instruction, a hovering instruction, a landing instruction or a forward flight instruction. If the flight instruction is a take-off instruction or a landing instruction, the control system may control the one or more of the plurality of tilting fan assemblies that are in the forward flight position to the vertical lift position. If the flight instruction is a forward flight instruction, the control system may control the one or more of the plurality of tilting fan assemblies that are in the vertical lift position to the forward flight tilt position. The control system may then determine a position of a plurality of tilting fan assemblies coupled to the aircraft and control one or more of the plurality of tilting fan assemblies between a vertical lift position and a forward flight position based on the flight instruction. The control system may continuously monitor the position of the plurality of tilting fan assemblies in view of the flight instruction.

FIG. 11 illustrates a block diagram 1100 of an example flight supervision platform 1106 that can be used by a supervisor 1102 to monitor and interact with one or more autonomous aircraft 1104 (e.g., aircraft 102) individually and/or collectively. The flight supervision platform 1106 may include a server computer 1108 comprising one or more processors 1110, a system memory 1112 (which may comprise any combination of volatile and/or non-volatile memory such as, for example, buffer memory, RAM, DRAM, ROM, flash, or any other suitable memory device), and a network interface (e.g., an external communication interface) 1114. For example, the network interface 1114 can be used to interface with the aircraft computing system 106 to provide landing site information. In some embodiments, one or more of the modules may be disposed within one or more of the components of the system memory 1112, or may be disposed externally. The server computer 1108 may further include a computer readable medium 1116 for storing one or more instructions. The software and hardware modules shown in FIG. 11 are provided for illustration purposes only, and the configurations are not intended to be limiting. The processors 1110, system memory 1112 and/or network interface 1114 may be used to implement the techniques and/or methods described herein.

The network interface 1114 may be configured or programmed to receive and generate electronic messages comprising information transmitted through the flight supervision platform 1106 to or from the plurality of autonomous aircraft 1104.

The flight supervision platform 1106 may also include at least one display device 1118 for displaying a graphical user interface (GUI) 1120. When an electronic message is received by the flight supervision platform 1106 via the network interface 1114 of the server computer 1108, it may be processed and relevant information may be displayed on the display device 1118 via the GUI 1120. When an input is received from the supervisor 1102 via the GUI 1120, it may be processed and relevant information may be transmitted to the corresponding autonomous aircraft 1104. For example, flight supervision platform can be used to provide the aircraft computing system 106 with landing site information (e.g., a landing site identifier). According to various embodiments, the flight supervision platform 1106 may further be configured to receive supplementary information from third parties, such as air traffic control, weather, other aircraft (e.g., aircraft that monitors the one or more autonomous aircraft 1104 in the air). The supplementary information may be processed by the flight supervision platform 1106 and displayed on the GUI 1120.

### Examples

In the following sections, further example embodiments are provided.

Example 1 can include a method performed by a pilotless aircraft computing system, the method comprising: determining that a pilotless aircraft, while approaching a landing site, is within a threshold range of a transceiver associated with the landing site; accessing a pilotless aircraft passcode based at least in part on determining that the pilotless aircraft is within the threshold range; transmitting, via a radio link, a first message to the transceiver based at least in part on determining that the pilotless aircraft is within the threshold range, the first message comprising the pilotless aircraft passcode; controlling the pilotless aircraft to perform a first set of maneuvers to land on the landing site if a second message is received from the transceiver based at least in part on transmitting the first message; and controlling the pilotless aircraft to perform a second set of maneuvers to divert toward a different landing site if no message is received from the transceiver in response to the first message or if an incorrect message is received.

Example 2 can include the method of example 1, wherein the method further comprises: receiving, via the radio link, a request message based at least in part on the first message, wherein request message requesting the pilotless aircraft to retransmit the first message; retransmitting, via a radio link, the first message to the transceiver in response to the request message; and receiving, via the radio link, the second message from the transceiver, wherein the second message echoes the first message and comprises the pilotless aircraft passcode.

Example 3 can include the method of any of examples 1 or 2, wherein the method further comprises: generating, using a randomizer, the pilotless aircraft passcode.

Example 4 can include the method of any of examples 1-3, determining a position of the pilotless aircraft while approaching the landing site; determining a position of the landing site; and determining a radio parameter of the transceiver associated with a landing site computing system, wherein determining that the pilotless aircraft is within the threshold range is based at least in part on the position of the pilotless aircraft, the position of the landing site, and the radio parameter.

Example 5 can include the method of any of examples 1-4, wherein the method further comprises processing the second message; and determining that the second message comprises the pilotless aircraft passcode based on analyzing before proceeding to implement the first set of maneuvers.

Example 6 can include the method of any of examples 1-5, wherein the method further comprises: determining that the second message comprises a request for a third message for requesting a status of the landing site; transmitting the third message for requesting the status of the landing site based at least in part on the second message; receiving, via the radio link, a fourth message based at least in part on transmitting the third message, wherein the fourth message echoes the first message and comprises the pilotless aircraft passcode; and controlling the pilotless aircraft to perform the first set of maneuvers to land on the landing site in response to the fourth message.

Example 7 can include the method of any of examples 1-6, wherein the method further comprises: accessing a pilotless aircraft identifier for the pilotless aircraft; accessing a landing site identifier for the landing site; and generating the first message to comprise the pilotless aircraft identifier, the landing site identifier, and the pilotless aircraft passcode.

Example 8 can include the method of any of examples 1-7, wherein the transceiver is a first transceiver, and wherein the method further comprises: establishing the radio link between a second transceiver associated with the pilotless aircraft computing system and the first transceiver.

Example 9 can include the method of example 8, wherein the first transceiver is configured to relay the first message to a second transceiver associated with the landing site.

Example 10 can include a computing system comprising one or more processors; and one or more computer-readable media having stored thereon instructions that, when executed, cause one or more processors to perform any of the steps of examples 1-9.

Example 11 can include one or more computer-readable media having stored thereon instructions that, when executed, cause one or more processors to perform any of the steps of examples 1-9.

Example 12 can include a method performed by a pilotless aircraft computing system, the method comprising: transmitting a first message to a landing site computing system based at least in part on determining that a pilotless aircraft is within a threshold range of a landing site, the first message comprising a first passcode; determining whether a second message comprising a second passcode is received from the landing site computing system in response to the first message, the second passcode corresponding to the first passcode; determining a subset of maneuvers for landing condition from a set of maneuvers based at least in part on determining whether the second message comprising a second passcode is received from the landing site computing system; and causing the pilotless aircraft to perform the subset of maneuvers for the landing condition.

Example 13 can include the method of example 12, wherein the first message is a first poll message, wherein the subset of maneuvers is a first subset of maneuvers, wherein the set of maneuvers comprises the first subset of maneuvers and a second subset of maneuvers, and wherein the method further comprises: receiving a third message requesting the pilotless aircraft to transmit a fourth message comprising a second poll message; transmitting the fourth message comprising a third passcode to the landing site computing system in response to the third message; determining that a fifth message in response to the fourth message has not been received from the landing site computing system; determining to cease performing the first subset of maneuvers based at least in part on determining that the fifth message in response to the fourth message has not been received from the landing site computing system; and determining to perform the second subset of maneuvers based at least in part on determining to cease performing the first subset of maneuvers.

Example 14 can include the method of example 12, further comprising: generating, using a randomizer, the first passcode based at least in part on determining that the pilotless aircraft is within the threshold range of the landing site; and incorporating the first passcode into the first message.

Example 15 can include the method of example 12, further comprising: determining a radio parameter of a transceiver signal associated with the landing site computing system, wherein determining that the pilotless aircraft is within the threshold range is based at least in part on the radio parameter.

Example 16 can include the method of example 12, further comprising: capturing an image of the landing site; and determining an image parameter of the image, wherein determining that the pilotless aircraft is within the threshold range is based at least in part on the image parameter.

Example 17 can include the method of example 12, further comprising: processing the second passcode; and determining that the second passcode corresponds to the first passcode before proceeding to implement the first set of maneuvers.

Example 18 can include the method of example 12, further comprising: starting a timer based at least in part on transmitting the first message to the landing site computing system; and determining an expiration of the timer, wherein determining whether a second message comprising a second passcode is received from the landing site computing system is based at least in part on expiration of the timer.

Example 19 can include a computing system comprising one or more processors; and one or more computer-readable media having stored thereon instructions that, when executed, cause one or more processors to perform any of the steps of examples 12-19.

Example 20 can include one or more computer-readable media having stored thereon instructions that, when executed, cause one or more processors to perform any of the steps of examples 12-19.

For simplicity, various active and passive circuitry components are not shown in the figures. In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Electronic components of the described embodiments may be specially constructed for the required purposes, or may comprise one or more general-purpose computers selectively activated or reconfigured by a computer program stored in the computer. Such a computer program may be stored in a computer readable storage medium, such as, but is not limited to, any type of disk including floppy disks, optical disks, DVDs, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each coupled to a computer system bus.

Additionally, spatially relative terms, such as “front or “back” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “front” surface can then be oriented “back” from other elements or features. The device can be otherwise oriented (e.g., rotated 90 degrees or at other orientations) and the spatially relative descriptors used herein interpreted accordingly.

What is claimed is:

1. A method performed by a pilotless aircraft computing system, the method comprising:
transmitting a first message to a landing site computing system based at least in part on determining that a pilotless aircraft is within a threshold range of a landing site, the first message comprising a first passcode;
determining whether a second message comprising a second passcode is received from the landing site computing system in response to the first message, the second passcode corresponding to the first passcode;
determining a subset of maneuvers for landing condition from a set of maneuvers based at least in part on determining whether the second message comprising a second passcode is received from the landing site computing system; and
controlling the pilotless aircraft to perform the subset of maneuvers for the landing condition.

2. The method of claim 1, wherein the first message is a first poll message, wherein the subset of maneuvers is a first subset of maneuvers, wherein the set of maneuvers comprises the first subset of maneuvers and a second subset of maneuvers, and wherein the method further comprises:
receiving a third message requesting the pilotless aircraft to transmit a fourth message comprising a second poll message;
transmitting the fourth message comprising a third passcode to the landing site computing system in response to the third message;
determining that a fifth message in response to the fourth message has not been received from the landing site computing system;
determining to cease performing the first subset of maneuvers based at least in part on determining that the fifth message in response to the fourth message has not been received from the landing site computing system; and
determining to perform the second subset of maneuvers based at least in part on determining to cease performing the first subset of maneuvers.

3. The method of claim 1, further comprising:
generating, using a randomizer, the first passcode based at least in part on determining that the pilotless aircraft is within the threshold range of the landing site; and
incorporating the first passcode into the first message.

4. The method of claim 1, further comprising:
determining a radio parameter of a transceiver signal associated with the landing site computing system, wherein determining that the pilotless aircraft is within the threshold range is based at least in part on the radio parameter.

5. The method of claim 1, further comprising:
capturing an image of the landing site; and
determining an image parameter of the image, wherein determining that the pilotless aircraft is within the threshold range is based at least in part on the image parameter.

6. The method of claim 1, further comprising:
processing the second passcode; and
determining that the second passcode corresponds to the first passcode before causing the pilotless aircraft to perform the subset of maneuvers.

7. The method of claim 1, further comprising:
starting a timer based at least in part on transmitting the first message to the landing site computing system; and
determining an expiration of the timer, wherein determining whether a second message comprising a second passcode is received from the landing site computing system is based at least in part on expiration of the timer.

8. A pilotless aircraft computing system comprising:
one or more processors, and
a one or more computer-readable media having stored thereon instructions that, when executed, cause the one or more processors to:
transmit a first message to a landing site computing system based at least in part on determining that a pilotless aircraft is within a threshold range of a landing site, the first message comprising a first passcode;
determine whether a second message comprising a second passcode is received from the landing site computing system in response to the first message, the second passcode corresponding to the first passcode;
determine a subset of maneuvers for landing condition from a set of maneuvers based at least in part on determining whether the second message comprising a second passcode is received from the landing site computing system; and
control the pilotless aircraft to perform the subset of maneuvers for the landing condition.

9. The pilotless aircraft computing system of claim 8, wherein the first message is a first poll message, wherein the subset of maneuvers is a first subset of maneuvers, wherein the set of maneuvers comprises the first subset of maneuvers and a second subset of maneuvers, and wherein the instructions that, when executed, further cause the one or more processors to:
receive a third message requesting the pilotless aircraft to transmit a fourth message comprising a second poll message;
transmit the fourth message comprising a third passcode to the landing site computing system in response to the third message;
determine that a fifth message in response to the fourth message has not been received from the landing site computing system;
determine to cease performing the first subset of maneuvers based at least in part on determining that the fifth message in response to the fourth message has not been received from the landing site computing system; and
determine to perform the second subset of maneuvers based at least in part on determining to cease performing the first subset of maneuvers.

10. The pilotless aircraft computing system of claim 8, wherein the instructions that, when executed, further cause the one or more processors to:
generate, using a randomizer, the first passcode based at least in part on determining that the pilotless aircraft is within the threshold range of the landing site; and
incorporate the first passcode into the first message.

11. The pilotless aircraft computing system of claim 8, wherein the instructions that, when executed, further cause the one or more processors to:
determine a radio parameter of a transceiver signal associated with the landing site computing system, wherein determining that the pilotless aircraft is within the threshold range is based at least in part on the radio parameter.

12. The pilotless aircraft computing system of claim 8, wherein the instructions that, when executed, further cause the one or more processors to:
capturing an image of the landing site; and
determining an image parameter of the image, wherein determining that the pilotless aircraft is within the threshold range is based at least in part on the image parameter.

13. The pilotless aircraft computing system of claim 8, wherein the instructions that, when executed, further cause the one or more processors to:
processing the second passcode; and
determining that the second passcode corresponds to the first passcode before causing the pilotless aircraft to perform the subset of maneuvers.

14. The pilotless aircraft computing system of claim 8, wherein the instructions that, when executed, further cause the one or more processors to:
starting a timer based at least in part on transmitting the first message to the landing site computing system; and
determining an expiration of the timer, wherein determining whether a second message comprising a second passcode is received from the landing site computing system is based at least in part on expiration of the timer.

15. One or more non-transitory, computer-readable storage media storing instructions that, when executed, cause one or more processors of a pilotless aircraft computing system to:
transmit a first message to a landing site computing system based at least in part on determining that a pilotless aircraft is within a threshold range of a landing site, the first message comprising a first passcode;
determine whether a second message comprising a second passcode is received from the landing site computing system in response to the first message, the second passcode corresponding to the first passcode;
determine a subset of maneuvers for landing condition from a set of maneuvers based at least in part on determining whether the second message comprising a second passcode is received from the landing site computing system; and
cause the pilotless aircraft to perform the subset of maneuvers for the landing condition.

16. The one or more non-transitory, computer-readable storage media of claim 15, wherein the first message is a first poll message, wherein the subset of maneuvers is a first subset of maneuvers, wherein the set of maneuvers comprises the first subset of maneuvers and a second subset of maneuvers, and wherein the instructions that, when executed, further cause the one or more processors to:
receive a third message requesting the pilotless aircraft to transmit a fourth message comprising a second poll message;
transmit the fourth message comprising a third passcode to the landing site computing system in response to the third message;
determine that a fifth message in response to the fourth message has not been received from the landing site computing system;
determine to cease performing the first subset of maneuvers based at least in part on determining that the fifth message in response to the fourth message has not been received from the landing site computing system; and
determine to perform the second subset of maneuvers based at least in part on determining to cease performing the first subset of maneuvers.

17. The one or more non-transitory, computer-readable storage media of claim 15, wherein the instructions that, when executed, further cause the one or more processors to:
generate, using a randomizer, the first passcode based at least in part on determining that the pilotless aircraft is within the threshold range of the landing site; and
incorporate the first passcode into the first message.

18. The one or more non-transitory, computer-readable storage media of claim 15, wherein the instructions that, when executed, further cause the one or more processors to:
determine a radio parameter of a transceiver signal associated with the landing site computing system, wherein determining that the pilotless aircraft is within the threshold range is based at least in part on the radio parameter.

19. The one or more non-transitory, computer-readable storage media of claim 15, wherein the instructions that, when executed, further cause the one or more processors to:
capturing an image of the landing site; and
determining an image parameter of the image, wherein determining that the pilotless aircraft is within the threshold range is based at least in part on the image parameter.

20. The one or more non-transitory, computer-readable storage media of claim 15, wherein the instructions that, when executed, further cause the one or more processors to:
processing the second passcode; and
determining that the second passcode corresponds to the first passcode before causing the pilotless aircraft to perform the subset of maneuvers.
